(19) United States
(12) Patent Application Publication
(10) Pub. No.: US 2008/0099140 A1
(43) Pub. Date: May 1, 2008

(54) Illuminated wood veneer and method of making same

(76) Inventor: Kevin J. Wardein, Naples, FL (US)

Correspondence Address: EDWARD M. LIVINGSTON, PA, 963 TRAIL TERRACE DRIVE, NAPLES, FL, 34103, US

(21) Appl. No.: 11/591,053

(22) Filed: Nov. 1, 2006

(51) Int. Cl. C09J 163/00

(52) U.S. Cl. 156/330; 428/537.1

(57) ABSTRACT

An illuminated wood veneer (1) and method of making same wherein sheets of wood veneer (12) and (13) are adhered to one another using an adhesive, such as gum tape (11) or hot glue, to create a predeterminedly sized wood veneer (2). Then, a predetermined amount of cloth (3), which is preferably muslim but may be linen or any other fabric, is secured to the wood veneer (2), preferably with a white glue in a vacuum or hot press. Then, epoxy is placed on a predeterminedly sized piece of mounting material (4), such as glass or plastic, to which the cloth (3) is then adhered to, to create a finished product. When the finished product is illuminated, a glow is achieved wherein the characteristics of the wood (8) are highlighted.

### BACKGROUND OF THE INVENTION

This invention relates to illuminated wood veneer, more particularly, illuminated wood veneer that is attractive and has minimally-noticeable seams.

Currently, wood veneers are illuminated by placing the wood veneers between two pieces of glass or plastic material and backlighting the glass or plastic material with a lighting source, such as a bulb or rope light. The illuminated wood veneers are used for a plurality of objects, such as countertops, furniture, lamps, etc. so as to give an exotic and unique appearance to the object. The wood veneer, although having the appearance of one sheet, is actually made of a plurality of sheets joined together. Each time the sheets are joined together, a seam is created. Although the seams may not be readily apparent when the wood veneer is not backlit, the appearance of the wood veneer seams is very noticeable when the wood veneer is illuminated. Although there have been attempts to hide the seams of illuminated wood veneers, none have been successful.

In addition, because the wood veneer is located between two pieces of glass or plastic material, the true beauty of the wood veneer is masked due to the reflection of the glass or plastic material.

Thus, a need exists for an illuminated wood veneer that minimizes the appearance of seams and is attractive.

The relevant prior art includes the following references:

| Patent No. | | |
|---|---|---|
| (U.S. unless stated otherwise) | Inventor | Issue/Publication Date |
| 6,547,419 | Brackman | Apr. 15, 2003 |
| 4,025,663 | Brandt | May 24, 1977 |
| 2005/0259427 | Clark | Nov. 24, 2005 |
| 6,958,182 | Hasecke et al. | Oct. 25, 2005 |
| 2004/0101668 | Peters et al. | May 27, 2004 |
| DE 19503776 | Haag et al. | Aug. 08, 1996 |
| DE 10212417 | Foss | Oct. 02, 2003 |
| DE 3931322 | Weissbeck | Mar. 28, 1991 |

### SUMMARY OF THE INVENTION

The primary object of the present invention is to provide an illuminated wood veneer that minimizes the appearance of seams.

A further object of the present invention is to provide an illuminated wood veneer that is attractive in appearance.

An even further object of the present invention is to provide an illuminated wood veneer that may be used for a variety of objects.

A further object of the present invention is to provide an illuminated wood veneer that does not bubble.

An even further object of the present invention is to provide an illuminated wood veneer that is waterproof.

Another object of the present invention is to provide a method for manufacturing an illuminated wood veneer that is durable.

The present invention fulfills the above and other objects by providing an illuminated wood veneer and method of making same wherein sheets of wood veneer are adhered to one another using an adhesive, such as gum tape or hot glue, to create a predeterminedly sized wood veneer. Then, a predetermined amount of cloth, which is preferably muslim but may be linen or any other fabric, is secured to the wood veneer, preferably with a white glue in a vacuum or hot press. Then, epoxy is placed on a predeterminedly sized piece of mounting material, such as glass or plastic, to which the cloth is then adhered to create a finished product. When the finished product is illuminated, a glow is achieved wherein the characteristics of the wood are highlighted.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a side view of an illuminated veneer of the present invention;

FIG. 2 is a front planar view of a method for adhering sheets of wood veneer to one another of the present invention; and

FIG. 3 is a front view of illuminated wood veneers of the present invention in an entertainment center.

### DESCRIPTION OF THE PREFERRED EMBODIMENTS

For purposes of describing the preferred embodiment, the terminology used in reference to the numbered components in the drawings is as follows:

| | |
|---|---|
| 1. | illuminated wood veneer, |
| | generally |
| 2. | wood veneer |
| 3. | cloth |
| 4. | mounting material |
| 5. | lighting apparatus |
| 6. | entertainment center |
| 7. | cabinet door |
| 8. | wood characteristics |
| 9. | knobs |
| 10. | first adhering means |
| 11. | gum tape |
| 12. | wood veneer first sheet |
| 13. | wood veneer second sheet |
| 14. | seam |
| 15. | second adhering means |
| 16. | panel |

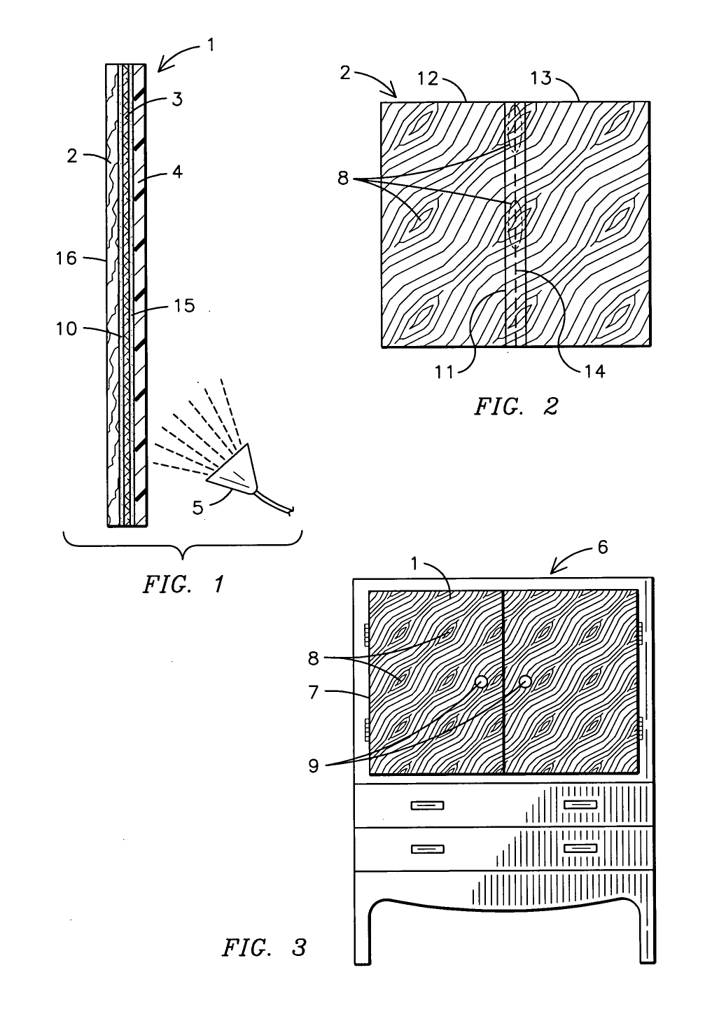

With reference to FIG. 1, is a side view of an illuminated veneer of the present invention is shown. The illuminated wood veneer, generally 1, is formed of a predeterminedly sized and shaped wood veneer 2, a predeterminedly sized and shaped cloth 3, which is preferably muslim but may be linen or any other fabric, and a predeterminedly sized and shaped mounting material 4 wherein, when the illuminated wood veneer 1 is in its finished form, a lighting apparatus 5 is utilized to backlight the illuminated wood veneer 1. The lighting apparatus 5 may be a bulb, rope light or any other lighting means and may be of varying colors. A first adhering means 10, which is preferably an adhesive such as white glue, is used to adhere the wood veneer 2 to the cloth 3. Then, the wood veneer 2 and cloth 3 are vacuumed pressed or hot pressed so as to remove any air bubbles located between the wood veneer 2 and cloth 3. Then, a second adhering means 15, which is preferably a two-part epoxy, is used to secure the cloth 3 to the mounting material 4, thereby creating a panel 16. The panel 16 is then vacuum pressed or hot pressed so as to remove any air bubbles located between the cloth 3 and mounting material 4. Because the white glue bonds with the cellular structures of the wood veneer 2, expansion and contraction of the wood veneer 2 is permitted without sacrificing the wood veneer 2 to cloth 3 securement. In addition, the two-part epoxy controls the expansion rate of the wood veneer 2 and the mounting material 4, thereby minimizing the expansion rate of same. Moreover, the use of cloth 3 further aids in reducing the amount in which the wood veneer 2 expands and contracts, thereby permitting a longer lasting adhesion of the wood veneer 2, cloth 3 and mounting material 4. The mounting material 4 is preferably a rigid, transparent material, such as glass or plastic, that may include but is not limited to plexiglass, Lexan®, etc., which allows light from a lighting apparatus 5 to illuminate the wood veneer 2.

In FIG. 2, a front planar view of a method for adhering sheets of wood veneer to one another of the present invention is shown. Prior to mounting the wood veneer 2 to the cloth 3, a wood veneer 2 having a large enough surface area must first be created. The current method for creating a large wood veneer 2 is by matching an edge of a first sheet of wood veneer 12 to an edge of a second sheet of wood veneer 13 wherein the edges join together to form a seam 14. One must take great care in matching the first sheet 12 to the second sheet 13 so as to create a uniform appearance of one large sheet of wood veneer 2 wherein wood characteristics 8 of the first sheet 12 smoothly transition with wood characteristics 8 of the second sheet 13. However, because the seam 14 is not manipulated, the seam 14 is readily visible when the wood veneer 2 is illuminated. By covering the seam 14 with a predetermined amount of adhesive, such as gum tape 11 or hot glue, the seam 14 is barely visible when the wood veneer 2 is illuminated. In addition, prior to adhering the wood veneer 2 to the cloth 3, the wood veneer 2 may be saturated with glycerin.

Finally, FIG. 3 shows a front view of illuminated wood veneers of the present invention in an entertainment center. The entertainment center 6 is an example of how the illuminated wood veneers 1 of the present invention may be incorporated with furniture. The illuminated wood veneer 1 may be used as a cabinet door 7 having knobs 9 so as to give a unique, one-of-a-kind appearance. However, the illuminated wood veneer 1 may also be used for other furniture, such as chairs, sofas, tables, countertops, desks, etc.

The illuminated wood veneer and method of making same will provide an attractive, long-lasting illuminated wood veneer that may be used on a plurality of objects, such as furniture and other decorative fixtures.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not be considered limited to what is shown and described in the specification and drawings.

Having thus described my invention, I claim:

1. A wood veneer comprising:
a predeterminedly sized wood veneer;
a predeterminedly sized cloth adhered to said predeterminedly sized wood veneer;
a predeterminedly sized mounting material adhered to said predeterminedly sized cloth;
a means for adhering said predeterminedly sized cloth to said predeterminedly sized wood veneer; and
a means for adhering said predeterminedly sized cloth to said predeterminedly sized mounting material.

2. The wood veneer of claim 1 further comprising:
a means for illuminating said wood veneer.

3. The wood veneer of claim 1 wherein:
said predeterminedly sized wood veneer is comprised of a wood veneer first sheet and a wood veneer second sheet joined together to form a seam.

4. The wood veneer of claim 2 wherein:
said predeterminedly sized wood veneer is comprised of a wood veneer first sheet and a wood veneer second sheet joined together to form a seam.

5. The wood veneer of claim 3 wherein:
said seam is covered with a predetermined amount of gum tape.

6. The wood veneer of claim 4 wherein:
said seam is covered with a predetermined amount of gum tape.

7. The wood veneer of claim 1 wherein:
said means for adhering said predeterminedly sized cloth to said predeterminedly sized wood veneer is via white glue.

8. The wood veneer of claim 1 wherein:
said means for adhering said predeterminedly sized cloth to said predeterminedly sized mounting material is via a two-part epoxy.

9. The wood veneer of claim 1 wherein:
said predeterminedly sized mounting material adhered to said predeterminedly sized cloth is a plastic.

10. The wood veneer of claim 2 wherein:
said means for illuminating said wood veneer is a light.

11. An illuminated wood veneer comprising:
a predeterminedly sized wood veneer comprised of a wood veneer first sheet and a wood veneer second sheet joined together to form a seam;
said seam is covered with a predetermined amount of gum tape;
a predeterminedly sized cloth adhered to said predeterminedly sized wood veneer;
a predeterminedly sized plastic material adhered to said predeterminedly sized cloth;
a means for adhering said predeterminedly sized cloth to said predeterminedly sized wood veneer;
said means for adhering said predeterminedly sized cloth to said predeterminedly sized wood veneer is via white glue;
a means for adhering said predeterminedly sized cloth to said predeterminedly sized mounting material;
said means for adhering said predeterminedly sized cloth to said predeterminedly sized mounting material is via a two-part epoxy; and
a light for illuminating said wood veneer.

12. A method for manufacturing a wood veneer comprising a predeterminedly sized wood veneer; a predeterminedly sized cloth adhered to said predeterminedly sized wood veneer; said predeterminedly sized wood veneer is comprised of a wood veneer first sheet and a wood veneer second sheet joined together to form a seam; a predeterminedly sized mounting material adhered to said predeterminedly sized cloth; a means for adhering said predeterminedly sized cloth to said predeterminedly sized wood veneer; and a means for adhering said predeterminedly sized cloth to said predeterminedly sized mounting material, said method comprising the steps of:
a. covering said seam with a predetermined amount of adhesive;
b. adhering said predeterminedly sized wood veneer to said predeterminedly sized cloth; and
c. adhering said predeterminedly sized wood veneer to said predeterminedly sized mounting material.

13. The method of claim 12 further comprising a step prior to step a of:
saturating said predeterminedly sized wood veneer with glycerin.

14. The method of claim 12 wherein:
said means for adhering said predeterminedly sized cloth to said predeterminedly sized wood veneer is via white glue.

15. The method of claim 12 wherein:
said means for adhering said predeterminedly sized cloth to said predeterminedly sized mounting material is via a two-part epoxy.

16. The method of claim 12 wherein:
said predeterminedly sized mounting material is a plastic.

17. The method of claim 14 wherein:
said means for adhering said predeterminedly sized cloth to said predeterminedly sized mounting material is via a two-part epoxy.

18. The method of claim 12 further comprising a step after step c of:
d. illuminating said wood veneer.

19. The method of claim 13 further comprising a step after step c of:
d. illuminating said wood veneer.

20. The method of claim 13 further comprising a step after step b of vacuum pressing said wood veneer and cloth and a step after step c of vacuum pressing said cloth and mounting material.

21. The wood veneer of claim 1 wherein:
said cloth is muslim.

22. The wood veneer of claim 11 wherein:
said cloth is muslim.

23. The method of claim 12 wherein:
said cloth is muslim.
